(19) United States
(12) Patent Application Publication
(10) Pub. No.: US 2026/0180643 A1
(43) Pub. Date: Jun. 25, 2026

(54) METHODS AND APPARATUSES FOR EFFICIENT MANAGEMENT OF CSI COMPUTATIONAL RESOURCES AND TIMELINE

(71) Applicant: InterDigital Patent Holdings, Inc., Wilmington, DE (US)

(72) Inventors: Mohammad Irfan, Chateauguay (CA); Afshin Haghighat, Ile-Bizard (CA); Loic Canonne-Velasquez, Dorval (CA); Moon IL Lee, Melville, NY (US); Virgil Comsa, Montreal (CA)

(73) Assignee: InterDigital Patent Holdings, Inc., Wilmington, DE (US)

(21) Appl. No.: 18/987,526

(22) Filed: Dec. 19, 2024

(51) Int. Cl. H04B 7/06; H04W 24/10

(52) U.S. Cl. CPC H04B 7/0626; H04W 24/10

(57) ABSTRACT

A wireless transmit/receive unit (WTRU) may receive a first channel state information (CSI) request and a second CSI request. The WTRU may determine a first active window for the first CSI request and a second active window for the second CSI request. The WTRU may determine, based on a first association rule, a first number of computational units (CUs) needed to process the first CSI request in the first active window and a second number of CUs needed to process the second CSI request in the second active window. The WTRU may determine that the second CSI request is an invalid CSI request based on the first number of CUs, the second number of CUs, and a number of CUs available to the WTRU. The WTRU may determine, based on a second association rule, a number of additional CUs needed to process the second CSI request in an active sub-window.

### BACKGROUND

A base-station (e.g., eNodeB (eNB), gNodeB (gNB), or the transmitter) configures measurement resources, e.g., channel state information (CSI) reference signal (RS) (CSI-RS) for the user equipment device (UE) (e.g., receiver) to measure, predict, or determine report quantities that represents the channel condition, e.g., PMI, RI, CQI, etc., termed as CSI in this document. The CSI measurement and reporting configurations includes static (e.g., fixed), semi-static (e.g., RRC and/or MAC-CE) and/or dynamic (e.g., DCI) indications for details (e.g., what to determine, e.g., report quantity, what to consider or assume, e.g., codebook configuration etc.) that the WTRU may need and the assumptions (e.g., active CSI-RS resource count, active CSI-RS antenna port count, active window, computational resources etc.,) that the WTRU may consider when determining, calculating, or predicting a CSI based on the received CSI-RS resources. The gNB and the WTRU needs to have a common understanding of the computational capabilities of the WTRU so that it may not configure the WTRU with CSI request(s) that the WTRU may not be able to handle or process. For example, the WTRU declares its capabilities to the gNB so that the gNB can avoid a misconfiguration of a CSI request.

The WTRU capability information supported in the existing specifications may be summarized as one or more of the following. Supported maximum number of configured non-zero power (NZP)-CSI-RS resources per component carrier (CC). Supported maximum number of configured CSI interference measurement (IM) resource per CC. Supported maximum number of CSI-RS antenna ports across all configured NZP-CSI-RS resources per CC. Supported maximum number of simultaneous NZP-CSI-RS resources in active bandwidth parts (BWPs) across all CCs. Supported maximum number of simultaneous NZP-CSI-RS resources per CC. Supported maximum total number of CSI-RS antenna ports in simultaneous NZP-CSI-RS resources in active BWPs across all CCs. Supported maximum number of total CSI-RS ports in simultaneous NZP-CSI-RS resources per CC. Simultaneous CSI reports per CC in a CC. Simultaneous CSI reports across all CCs. One or more of the above-mentioned WTRU capabilities may be referred to as basic capabilities or legacy capabilities of the WTRU.

### SUMMARY

In response to a valid CSI request, the wireless transmit/receive unit (WTRU) may determine a number of computational resources needed to determine a channel state information (CSI) in an active window of a CSI request based on an association rule. In response to an invalid CSI request, the WTRU may use more computational resources to process than the ones determined based on the association rule to process the invalid CSI request. In response to an invalid CSI request, the WTRU may extend and/or shift the active window of the invalid CSI request, for example, to process the invalid CSI request using the computational resources determined based on the computational resources.

A WTRU may receive a first CSI request and a second CSI request. The WTRU may determine a first active window for the first CSI request and a second active window for the second CSI request. The WTRU may determine, based on a first association rule, a first number of computational units (CUs) needed to process the first CSI request in the first active window and a second number of CUs needed to process the second CSI request in the second active window. The WTRU may determine that the second CSI request is an invalid CSI request based on the first number of CUs, the second number of CUs, and a total number of CUs available to the WTRU. The WTRU may determine an active sub-window for the second CSI request. The WTRU may determine, based on a second association rule, a number of additional CUs needed to process the second CSI request in the active sub-window. On a condition that the determined number of additional CUs are available, the WTRU may process the second CSI request. On a condition that the determined number of additional CUs are not available, the WTRU may shift the second active window in time to determine a dynamic active window to process the second CSI request. The WTRU may send a CSI report that is associated with the second CSI request.

The WTRU may send a capability report that indicates one or more of the total number of CUs available to the WTRU, a number of sub-CUs in one or more of the CUs, a time duration of each CU and each sub-CU, an active window, an active sub-window, or the dynamic active window. The WTRU may receive one or more first CSI-RS resources associated with the first CSI request and one or more second CSI-RS resources associated with the second CSI request. The first association rule may include one or more time-related and/or codebook related parameters associated with the one or more of the first CSI request or the second CSI request. The second association rule may be associated with a number of overlapped time-units in the second active window of the second CSI request. The WTRU may determine a CSI in the dynamic active window when the number of additional CUs are available. The number of additional CUs may be determined based on the first association rule. The second CSI request may be determined to be an invalid request based on the second number of CUs needed to process the second CSI request in the second active window being greater than the number of available CUs. The WTRU may send a CSI request ID and/or an indication that the CSI associated with the CSI request ID is being determined and ready for reporting.

The WTRU may receive uplink resources to be used for sending the CSI report. The active sub-window for the second CSI request may be a subset of the second active window. The first active window may start at a first time-unit and end at a second time-unit. The second active window may start at a third time-unit and end at a fourth time-unit. The first number of CUs needed to process the first CSI request in the first active window may be determined based on a first duration of the first active window, and wherein the second number of CUs needed to process the second CSI request in the second active window are determined based on a second duration of the second active window.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a flow chart illustrating using computational resources for channel state information (CSI) determination based on one or more association rules.

FIG. 3 is a diagram illustrating WTRU behavior of CSI determination in a fixed active window, an active sub-window, and in a dynamic active window.

FIG. 4 is a diagram illustrating an example case of reported capability.

FIG. 5 is a diagram illustrating candidate time-units starting time-unit and ending time unit of an active window when the CSI reference signal (CSI-RS) resources are aperiodic.

FIG. 6 is a diagram illustrating active windows in periodic and semi-persistent CSI-RS, including candidate time-units of the first and last time-unit of each active window.

### DETAILED DESCRIPTION

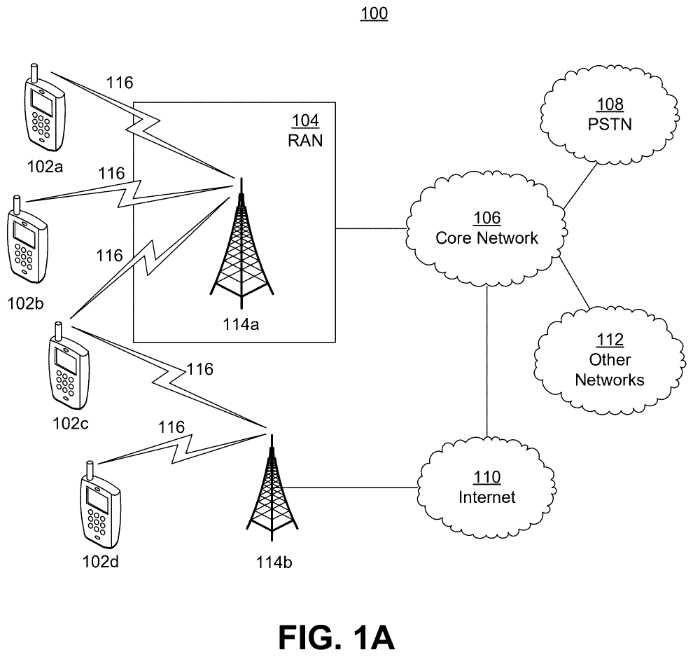

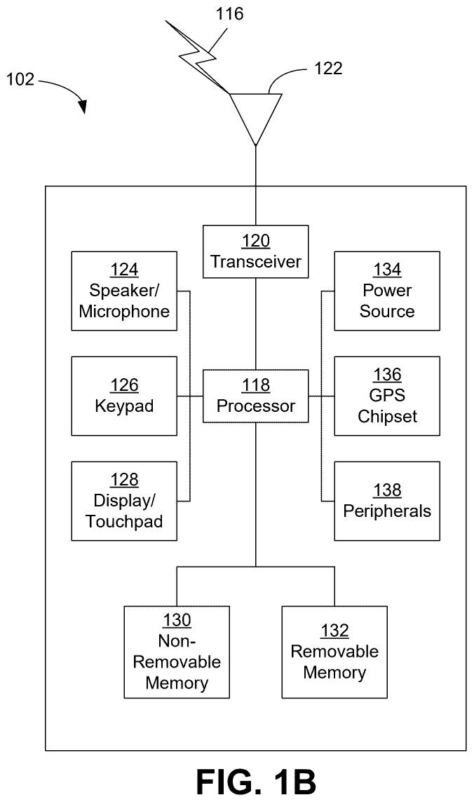

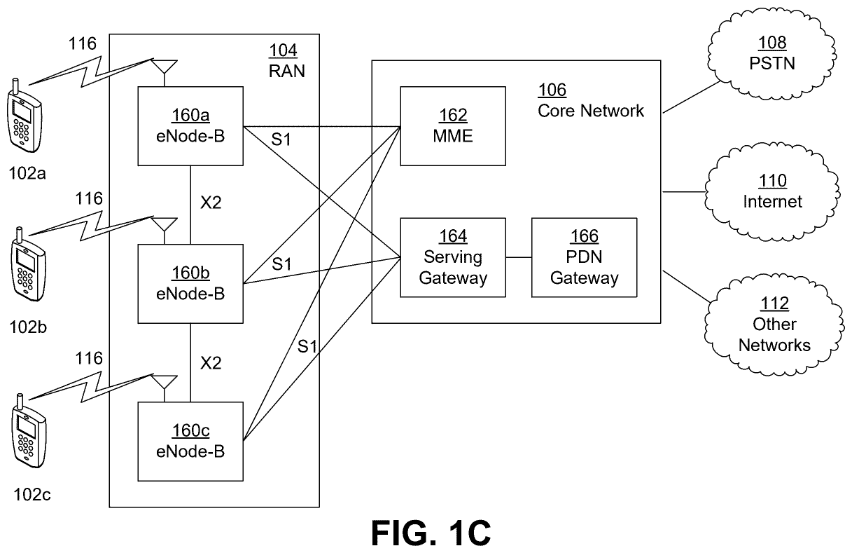

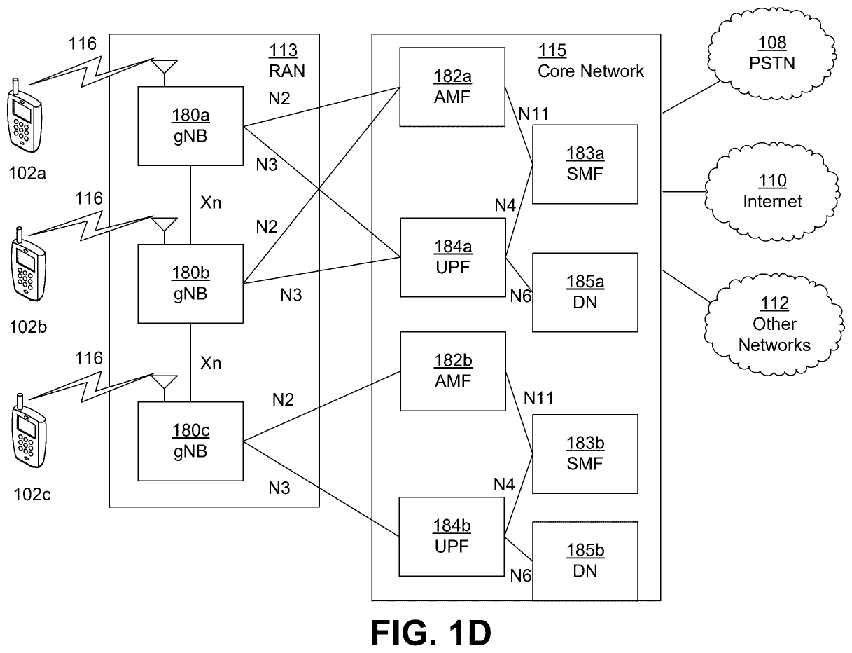

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The duration of an active CSI-RS resource and/or active antenna ports may depend on the type of CSI-RS, e.g., periodic CSI-RS, semi-persistent CSI-RS, or aperiodic CSI-RS.

For aperiodic CSI-RS, one or more CSI-RS resources and/or one or more CSI-RS antenna ports may be active starting from the end of the trigger, e.g., such as a PDCCH that includes the CSI request to the end of the uplink transmission or a PUSCH where the determined CSI is reported.

For semi-persistent CSI-RS, one or more CSI-RS resources and/or one or more CSI-RS antenna ports may be active starting from the end of the activation command and may end at the end of the de-activation command.

For periodic CSI-RS, one or more CSI-RS resources and/or one or more CSI-RS antenna ports may be active starting from when the CSI-RS is configured semi-statically, e.g., an RRC and may end when the CSI-RS configuration is released.

A WTRU may count active resources and/or CSI-RS antenna ports. During the duration in which the CSI-RS resource(s) and/or the CSI-RS antenna port(s) are active is counted both by the gNB and/or by the WTRU so that the WTRU capability of active resources in a CC or across CCs and/or the capability of active CSI-RS antenna ports may be respected by the gNB by not configuring or requesting a number of CSI requests that the WTRU may not be capable to process or to determine. Therefore, in any given slot, the WTRU does not expect to be configured to have more active CSI-RS antenna ports or more active CSI-RS resources than reported as capability.

For example, in a given slot and/or in an active bandwidth part (BWP), the WTRU may be configured with 2 CSI-RS resources, where the first CSI-RS resource may be mapped to 4 CSI-RS antenna ports and the second CSI-RS resource may be mapped to 8 CSI-RS antenna ports. The WTRU may count the number of active CSI-RS resources as 2 or any other number that is assigned as a count to the CSI-RS resource of the CSI type. The WTRU may count the number of active CSI-RS antenna ports as 12.

The WTRU may declare a number of computational units (CUs) that the WTRU supports for determination of CSI requests. During the active duration, the WTRU may use a number of CUs for determination of the requested CSI report(s). The number of CUs used for a CSI report may depend on the type of the CSI request, e.g., a signal-to-noise and interference ratio (SINR), one or more time-domain channel properties (TDCP), etc. For example, the WTRU may use 1 CU when the CSI request is SINR.

The number of CUs needed for determination of a CSI may be hard-coded and/or defined fixed, for example, regardless of the active CSI-RS duration and/or active CSI-RS antenna ports duration. The gNB may request the WTRU to determine a first CSI report (e.g., wideband PMI) that requires N₁ number of CUs in a first active CSI-RS resource duration and/or a first active CSI-RS antenna port duration of t₁ time unit(s). The gNB may also request the same first CSI report (e.g., wideband PMI) that requires the same N₁ number of CUs in a second active CSI-RS resource duration and/or a second active CSI-RS antenna port duration of t₂ time unit(s) with t₁≠t₂.

Therefore, the computational resources utilization may be considered as inefficient. Using a fixed number of CUs regardless of the CSI request and/or active duration may be sufficient for the current 5G requirements but may not be sufficient for beyond 5G requirements, where the gNB may sometimes request a larger number of CSI reports but with longer active durations and/or a smaller number of CSI reports but with shorter active durations. In such a scenario or requirements, the WTRU behavior based on the existing CUs management framework fails to process the CSI requests.

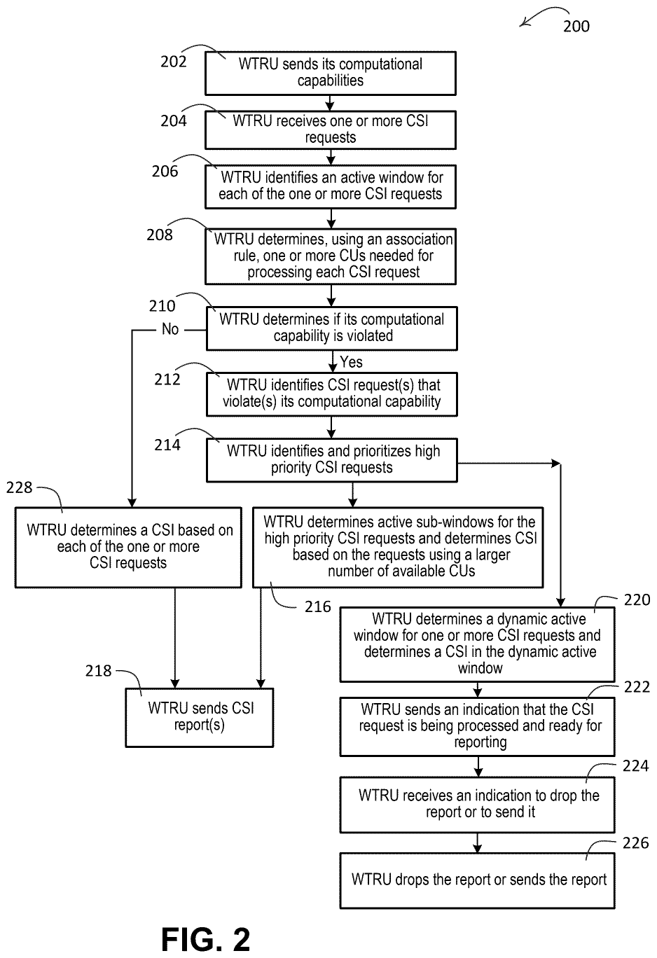

FIG. 2 depicts a flow chart illustrating an example method 200 of using computational resources for channel state information (CSI) determination based on one or more association rules. At 202, a WTRU may send one or more computation capabilities. The one or more computational capabilities may include one or more capability reports, for example, regarding device architecture. The one or more capability reports may include indications for one or more of the following: a number of CUs, a number of sub-CUs in one or more of the CUs, a time duration per CU and/or per sub-CU, an active window, an active sub-window, or a dynamic active window.

At 204, the WTRU may receive one or more CSI requests, e.g., such as a first CSI request and/or a second CSI request. The WTRU may receive one or more measurement resources (e.g., CSI-RS(s)) associated with the one or more CSI requests, e.g., a first CSI-RS resource associated with a first CSI request and/or a second CSI-RS resource associated with a second CSI request.

At 206, the WTRU may determine an active window associated with each of the one or more CSI requests. The active window may be a time-window used by the WTRU to determine a CSI based on the CSI request, e.g., a first active window and/or a second active window. A first active window and a second active window may overlap in one or more time-units, e.g., the first window starts from time-unit 1 and ends at time unit 10, the second window starts from time-unit 5 and ends at time unit 15, and the first and second windows are overlapping from time-unit 5 to time-unit 10.

At 208, the WTRU may determine, using a first association rule that involves, one or more time-related and/or one or more codebook related parameters associated with a CSI request of the one or more CSI requests, a number of computational units (CUs) that are needed to process the CSI request in its active window, e.g., a first set of CUs to process the first CSI request in a first active window and/or a second set of CUs to process the second CSI request in a second active window.

At 210, the WTRU may determine if its computational capability is violated (e.g., by the one or more CSI requests). If the computational capability of the WTRU is violated, the WTRU may identify, at 212, one or more valid and/or one or more invalid CSI requests. For example, the WTRU may have 4 CUs but 2 CUs (e.g., only 2 CUs) are available (e.g., 2 CUs are busy processing the first request) in the second active window. The WTRU may need 3 CUs to process the second CSI request in the second active window. If 1 CU (e.g., only 1 CU) is available, the second CSI request may be an invalid CSI request. If the computational capability is not violated (e.g., by the one or more CSI requests), the WTRU may determine, at 228, a CSI report based on each of the one or more CSI requests. And, the WTRU may send, at 218, may send the CSI report.

At 214, the WTRU may identify and may prioritize one or more high priority CSI requests. For example, the WTRU may process the first CSI request, send the first CSI report, and/or release the CUs used for determination of the first CSI report at the end of the first active window. For example, the WTRU may release 2 CUs at time-unit 10 (e.g., at time-unit 11 all 4 CUs are available).

At 216, the WTRU may determine an active sub-window associated with the one or more high priority CSI requests and may determine CSI based on the high priority requests, for example, using a larger number of available CUs. an invalid CSI request. For example, the active sub-window associated with the second CSI request is from time-unit 10 to time-unit 15. At 218, the WTRU may send the CSI reports.

At 220, the WTRU may determine a dynamic active window for one or more CSI requests and may determine a CSI in the dynamic active window, for example, using the same number of CUs needed to determine the CSI in the fixed active window, or more (or less) number of CUs needed to determine the CSI in the fixed active window. The dynamic active window may have the same (or different) duration or the number of time-unit(s) as the fixed active window but the dynamic active window may be delayed in time, e.g., the dynamic active window may end after the fixed active window associated with the CSI request.

The WTRU may determine, using a second association rule that involves a number of overlapped time-units in the active window of the invalid CSI request, one or more additional CUs needed to process the invalid CSI request in its active sub-window. For example, based on the second association rule, the WTRU may need one additional or in total 3 CUs to process the request in its active sub-window.

The WTRU may do at least one of the following. The WTRU may process the invalid CSI request when the additional CUs determined using the second association rule are available and the WTRU may send the CSI report. The WTRU may process the invalid CSI request, for example, by shifting the active window of the invalid CSI request in time (e.g., dynamic window) and may determine a CSI when sufficient CUs determined based on the first association rule are available. For example, the shifted or dynamic active window of the 2nd CSI request may start from time-unit 10 and may end at time-unit 11.

At 222, the WTRU may send an indicator that indicates that the CSI request ID and/or an indication that the CSI for the indicated request is being determined and ready for reporting. At 224, the WTRU may receive an indication that indicates to drop the CSI report or send the CSI report. The WTRU may receive one or more uplink resources, e.g., a PUCCH resource or a PUSCH resource for reporting the CSI report determined in the dynamic active window. At 226, the WTRU may drop or send the CSI report, for example, based on the received indication.

The WTRU may determine a number of CUs for processing CSI requests based on a first association rule. In the event of a WTRU computational capability violation, the WTRU may determine one or more additional CUs using a second association rule and may process the CSI request in a smaller active window, termed as the active sub-window. The WTRU may shift and/or extend the active window in time and may process the CSI request in the extended active window.

The WTRU may utilize its computational resources for CSI determination based on one or more association rules. Proposed methods and procedures described herein enable the WTRU to respond to a very dynamic behavior of gNB in terms of CSI request.

A WTRU may receive a first channel state information (CSI) request and a second CSI request. The WTRU may determine a first active window for the first CSI request and a second active window for the second CSI request. The WTRU may determine, based on a first association rule, a first number of computational units (CUs) needed to process the first CSI request in the first active window and a second number of CUs needed to process the second CSI request in the second active window. The WTRU may determine that the second CSI request is an invalid CSI request based on the first number of CUs, the second number of CUs, and/or a total number of CUs available to the WTRU. The WTRU may determine an active sub-window for the second CSI request. The WTRU may determine, based on a second association rule, a number of additional CUs needed to process the second CSI request in the active sub-window. On a condition that the determined number of additional CUs are available, the WTRU may process the second CSI request. On a condition that the determined number of additional CUs are not available, the WTRU may shift the second active window in time to determine a dynamic active window to process the second CSI request. The WTRU may send a CSI report that is associated with the second CSI request.

The WTRU may send a capability report that indicates one or more of the total number of CUs available to the WTRU, a number of sub-CUs in one or more of the Cus, a time duration of each CU and each sub-CU, an active window, an active sub-window, or the dynamic active window. The WTRU may receive a first CSI-RS resource associated with the first CSI request and a second CSI-RS resource associated with the second CSI request. The first association rule may include one or more time-related and/or codebook related parameters associated with the one or more of the first CSI request or the second CSI request. The second association rule may be associated with a number of overlapped time-units in the second active window of the second CSI request. The WTRU may determine a CSI in the dynamic active window when the number of additional CUs are available. The number of additional CUs may be determined based on the first association rule. The second CSI request may be determined to be an invalid request based on the second number of CUs needed to process the second CSI request in the second active window being greater than the number of available CUs. The WTRU may send a CSI request ID and/or an indication that the CSI associated with the CSI request ID is being determined and ready for reporting.

The WTRU may receive uplink resources to be used for sending the CSI report. The active sub-window for the second CSI request may be a subset of the second active window. The first active window may start at a first time-unit and end at a second time-unit. The second active window may start at a third time-unit and end at a fourth time-unit. The first number of CUs needed to process the first CSI request in the first active window may be determined based on a first duration of the first active window, and wherein the second number of CUs needed to process the second CSI request in the second active window are determined based on a second duration of the second active window.

Throughout this disclosure, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’.

TRP (e.g., transmission and reception point) may be interchangeably used herein with one or more of TP (transmission point), RP (reception point), RRH (radio remote head), DA (distributed antenna), BS (base station), a sector (of a BS), and a cell (e.g., a geographical cell area served by a BS), but still consistent with this invention. Multi-TRP may be interchangeably used herein with one or more of MTRP, M-TRP, and multiple TRPs.

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

A signal may be interchangeably used herein with one or more of following: Sounding reference signal (SRS), Channel state information-reference signal (CSI-RS), Demodulation reference signal (DM-RS), Phase tracking reference signal (PT-RS), Synchronization signal block (SSB).

A channel may be interchangeably used herein with one or more of following: a physical downlink control channel (PDCCH), a physical downlink shared channel (PDSCH), a physical uplink control channel (PUCCH), a physical uplink shared channel (PUSCH), a physical random access channel (PRACH), etc.

A quantity, report quantity, and/or channel state information (CSI) may be interchangeably used herein with one or more of following: a rank indicator (RI), a precoding matrix indicator (PMI), a channel quality indicator (CQI), a wideband channel quality indicator (W-CQI), a sub-band channel quality indicator (S-CQI), a wideband precoding matrix indicator (i1), a layer indicator (LI), a CSI reference resource index (CRI), a signal to noise and interference ratio (SINR), a reference signal received power (RSRP), etc.

The term power may be interchangeably used herein with the terms, energy, power of one resource element (EPRE), transmit power, transmitting power.

Downlink transmission or downlink reception may be used interchangeably herein with Rx occasion, PDCCH, PDSCH, SSB reception, but still consistent with this invention.

Uplink transmission or uplink reception may be used interchangeably herein with Tx occasion, PUCCH, PUSCH, PRACH, SRS transmission.

RS may be interchangeably used herein with one or more of RS resource, RS resource set, RS port and RS port group.

RS may be interchangeably used herein with one or more of SSB, CSI-RS, SRS and DM-RS.

Time instance or time-unit may be interchangeably used herein with slot, symbol, subframe.

Frequency instance or frequency unit may be interchangeably used herein with subcarrier, resource element (RE), sub-band, band, bandwidth part.

CSI reference slot, CSI reference resource, CSI reference resource slot, or reference slot may be interchangeably used herein.

The terms prediction, determination, calculation, and estimation may be used interchangeably herein.

CSI processing unit may refer to the computational resource(s) used to determine a CSI report.

The term, “antenna unit” may herein refer to a physical antenna element or a logical antenna port etc.

Sub-set of antenna unit(s), and/or subset of pilot symbol(s) may be interchangeably used herein with CSI-RS resource(s).

An active CSI-RS resource (or active CSI-RS resources) may herein refer to a CSI-RS resource (or CSI-RS resources) that is (or are) counted as active CSI-RS resource (or active CSI-RS resources) by the active CSI-RS resource (or active CSI-RS resources) counter of the WTRU.

An active CSI-RS antenna port (or active CSI-RS antenna ports) may herein refer to a CSI-RS antenna port (or CSI-RS antenna ports) that is (or are) counted as active CSI-RS antenna port (or active CSI-RS antenna ports) by the active CSI-RS antenna port (or active CSI-RS antenna ports) counter of the WTRU.

Active window may herein refer to a time window or the time window in which one (or more) CSI-RS resource(s) is (are) counted as active and/or a time window or the time window in which one or more CSI-RS antenna port(s) that is (are) mapped to an active CSI-RS resource is counted as an active antenna port(s).

A computational unit (CU) may herein refer to a computational device, e.g., a central processing unit (CPU), a sub-unit of a CPU, e.g., a CPU thread, etc.

CU may be used interchangeably herein with sub-CU.

The term processing a CSI request may be interpreted herein as determining a CSI based on the CSI request.

Semi-static or dynamic indication and/or configuration may herein refer to a configuration and/or indication using a Radio resource control (RRC), medium access control (MAC) control element (CE) (MAC-CE) and/or downlink control information (DCI).

The WTRU may declare or send the computational capability it possesses for processing CSI requests and/or for determining the requested CSI report, to the gNB. For example, the WTRU may declare one or more of the basic capabilities or legacy capabilities. The WTRU may declare and/or send one or more of the advanced capabilities the WTRU possesses to the gNB.

The WTRU may support N number of CUs, and/or one or more CUs may have sub-CUs and/or one or more sub-CUs may have an associated reference time-duration. The reference time-duration may be an indication that the sub-CU can perform a given number of flops during the reference time-duration, or the sub-CU of the WTRU can perform a CSI determination task, e.g., the task of SINR determination or the task of PMI determination for a given codebook type and codebook configuration during the reference time-duration. For example, the WTRU may support N_{CU} CUs where n=1, . . . , N. The nₜₕ CU has m∈{1, . . . , M} number of sub-CU, N_{n,m} is the mₜₕ sub-CU of the nₜₕ CU. When N=2 and M=3, the WTRU may support one or more of the following CUs, N_{1,1}, N_{1,2}, N_{1,3}, N_{2,1}, N_{2,2}, and/or N_{2,3}.

The WTRU may report the supported values of n and m or N and M to the gNB.

One or more CUs and/or one or more sub-CUs of one or more CUs may have the same computational capabilities or computational power. For example, e.g., N_{n,m} may have the same or different computational power as N_{n,m+1}, or N_{n+1,m}, or N_{n+1,m+1}. When one or more CUs and/or one or more sub-CU has the same computational power, the WTRU may send a single capability indication for the one or more sub-CU having the same computational power, to indicate their computational power. When one or more CUs and/or one or more sub-CU has different computational power, the WTRU may send a single capability indication for each CU or each sub-CU associated with a CU, to indicate their computational power. The reference time-duration associated with each sub-CU or associated with each CU may be an implicit or explicit indication of the computational power of the CU or the sub-CU.

The WTRU may report a reference time duration for one or more CUs or a reference time duration for one or more sub-CUs, where a reference time duration associated with a CU or a sub-CU may be an indication of the computational power of the CU or the sub-CU.

The computational power of each of the sub-CU of a CU or the computational power of each of the sub-CU of one or more CUs (e.g., all CUs) may be the same. In that case, the total number of CUs may be denoted as N_{CU}=N×M.

The WTRU may semi-statically or dynamically (e.g., by RRC, MAC-CE, and/or DCI) receive one or more CSI-RS configurations and/or one or more indications, requesting one or more CSI reports. Each CSI request may have associated fixed, semi-statically, dynamic configurations and/or indications that indicates one or more of the following. Each CSI request may have associated fixed, semi-statically, dynamic configurations and/or indications that indicates a codebook type, e.g., Type-I single panel codebook or Type-II single panel codebook, Type-I codebook mode-1, or Type-I codebook mode-2, etc. Each CSI request may have associated fixed, semi-statically, dynamic configurations and/or indications that indicates a DFT oversampling. Each CSI request may have associated fixed, semi-statically, dynamic configurations and/or indications that indicates a number of ports, e.g., a number of ports when Rel-19 Type-I Scheme-A codebook is configured and/or a number of ports when Rel-19 Type-I Scheme-B codebook is configured. Each CSI request may have associated fixed, semi-statically, dynamic configurations and/or indications that indicates a number of time domain basis/Doppler domain basis in high Doppler Type-II codebook. Each CSI request may have associated fixed, semi-statically, dynamic configurations and/or indications that indicates a frequency domain, a time domain, and/or one or more spatial domain compression parameters, e.g., a number of non-zero coefficients in a Type-II CSI report and/or a number of precoders per sub-bands. Each CSI request may have associated fixed, semi-statically, dynamic configurations and/or indications that indicates a number of sub-bands. Each CSI request may have associated fixed, semi-statically, dynamic configurations and/or indications that indicates a CSI-RS reporting type, e.g., periodic, semi-persistent, or aperiodic. Each CSI request may have associated fixed, semi-statically, dynamic configurations and/or indications that indicates a CSI type, e.g., periodic, semi-persistent, or aperiodic. Each CSI request may have associated fixed, semi-statically, dynamic configurations and/or indications that indicates a number of CSI-RS antenna ports, e.g., 32 CSI-RS ports. Each CSI request may have associated fixed, semi-statically, dynamic configurations and/or indications that indicates CSI-RS resources, including a number of CSI-RS resources in a CSI-RS resource set. Each CSI request may have associated fixed, semi-statically, dynamic configurations and/or indications that indicates a number and indexes of CSI-RS antenna ports per resource and/or per resource set. Each CSI request may have associated fixed, semi-statically, dynamic configurations and/or indications that indicates locations and/or indexes of time and/or frequency units where the CSI-RSs may be received and time and/or frequency units where the determined CSI may be reported. Each CSI request may have associated fixed, semi-statically, dynamic configurations and/or indications that indicates allow rank values or layer indices, e.g., rank indicator (RI)-restriction bitmap is configured. The RI-restriction bitmap indicates to the WTRU the layer indices and the number of layers, for which the WTRU may determine and report a precoder and/or a RI value. For example, the WTRU may support 8 layers. The WTRU may receive a bitmap [1 0 1 1 0 0 0 0], where each bit is associated with a layer index. Based on the bitmap, the WTRU may report (e.g., only report) a maximum rank value of RI=3 and report precoders/PMIs for layer 1, 3, and 4.

For example, the gNB may request the WTRU to determine and report P number of CSI reports. Hereinafter, unless otherwise stated, the active windows associated with the P number of CSI requests may be assumed to have at-least one common time-unit or may overlap in at-least one common unit.

The first association rule may be used by the WTRU to determine the number of CUs needed to process a CSI request in the fixed active window of the CSI request.

One or more association rules may be defined, specified, indicated, or configured to the WTRU. The association rule may be used by the WTRU to select a number of CUs, or sub-CUs and use them to determine a CSI within the active window of the configured CSI request. Examples of association rules are provided in Table I, Table II, and Table III. The association rule may be fixed, or it may be semi-statically or dynamically configured or indicated to the WTRU.

For example, a single association rule may be defined or configured to the WTRU, e.g., such as the example association rule of Table 1.

In another example, the requested report quantity may be associated with an association rule. For example, when the report quantity is PMI, the association rule in Table 1 is used. In another example, when the report quantity is PMI and sub-band(S) CQI, the association rule in Table 2 is used. In another example, when the report quantity is RI, PMI, the association rule in Table 3 is used.

Additionally or alternatively, the association rule may be defined using an equation, e.g., the WTRU determines the number of CUs for the pₜₕ (p=1, . . . , P) CSI report based on the following example equation,

$${O}_{c p u}^{p} = {K}_{p} {T}_{p} \qquad ( 1 )$$

Where Tₚ is a duration of the active window of the pₜₕ CSI request in terms of time-units, and where Kₚ is a constant whose value depends on one or more of the parameters listed in Section 4.2.2.

The second association rule may be used by the WTRU to determine an additional number of CUs to process a CSI request in the active sub-window of the CSI request.

One or more second association rules may be defined, specified or configured to the WTRU. The second association rule may include one or more parameters of the first association rule and the number of overlapped time-units that causes CUs computational capability violation, or the difference between the number of time-units in the fixed active window of the CSI request and the active sub-window of the CSI request, e.g., number of time units in the fixed active window-number of time-units in the active sub-window. Such overlapped time-units or difference is denoted by the column overlapped/difference in the Table

We assume a single CSI request by the gNB to explain using examples, how the WTRU may use an association rule to select a number of CUs for determination of the CSI or to process the CSI request. Table 1 depicts an example association rule for a number of CUs determination based on DFT oversampling and the duration of the active window.

TABLE 1

| | | | Active window | |
|---|---|---|---|---|
| | Report | DFT | duration in | Number |
| Codepoint | quantity | oversampling | time-units | of CUs |
| 1 | PMI | 2 | 1 | 2 |
| 2 | PMI | 2 | 2 | 1 |
| 3 | PMI | 4 | 1 | 2 |
| 4 | PMI | 4 | 2 | 3 |

Based on the association rule example in Table 1, when the report quantity is PMI and the DFT oversampling is 2 and the active window duration is 1 time-unit, the WTRU may use 2 CUs for determination of the CSI and when the active window duration is 2 time-units, the WTRU may use 1 CU for determination of the CSI report. The reason may be that the longer active window requires a smaller number of computational resources as compared to the computational resources required in a longer active window, for the same CSI request. Table 2 depicts an example association rule for a number of CUs determination based on the number of sub-bands and the duration of the active window.

TABLE 2

| | | | Active window | |
|---|---|---|---|---|
| | Report | Number of | duration in | Number |
| Codepoint | quantity | sub-bands | time-units | of CUs |
| 1 | PMI-SCQI | 5 | 1 | 1 |
| 2 | PMI-SCQI | 10 | 1 | 2 |
| 3 | PMI-SCQI | 10 | 2 | 1 |
| 4 | PMI-SCQI | 15 | 2 | 3 |
| 5 | PMI-SCQI | 20 | 2 | 4 |

Based on the first association rule example in Table 2, when the report quantity is PMI and sub-band CQI, and the number of sub-bands are 5, and the active window duration is 1 time-unit, the WTRU uses 1 CUs for determination of the CSI and when the number of sub-bands is 10 time-units and the active window is 1 time-unit, the WTRU uses 2 CU for determination of CSI report. The reason may be that a larger number of sub-bands and a shorter active window requires a larger number of computational resources as compared to the computational resources required in a longer active window for the same number of sub-bands, for the same CSI request. Table 3 depicts an example association rule for a number of CUs determination based on the allowed rank value or the number of allowed layers and the duration of the active window.

TABLE 3

| | | | Active window | |
|---|---|---|---|---|
| | Report | Allowed | duration in | Number |
| Codepoint | quantity | rank/layers | time-units | of CUs |
| 1 | RI-PMI | 1 | 1 | 2 |
| 2 | RI-PMI | 1 | 2 | 1 |
| 3 | RI-PMI | 2 | 3 | 2 |
| 4 | RI-PMI | 2 | 4 | 1 |
| 5 | RI-PMI | 3 | 5 | 1 |
| 6 | RI-PMI | 4 | 6 | 2 |

Based on the first association rule example in Table 3, when the report quantity is RI and PMI and the number of allowed rank value or the number of allowed layers is 1, and the active window duration is 1 time-unit, the WTRU uses 2 CUs for determination of the CSI and when the number of allowed rank or layer is 1 and the active window duration is 2 time-units, the WTRU uses 1 CU for determination of CSI report. The reason may be that a larger number of allowed rank value and a shorter active window requires a larger number of computational resources as compared to the computational resources required in a longer active window for the same rank value. Table 4 depicts an example of a second association rule, when the first association rule is the association rule in Table 3.

TABLE 4

| | | | Active | | |
|---|---|---|---|---|---|
| | | | window | | Additional |
| | Report | Allowed | duration in | Overlapped/ | number |
| Codepoint | quantity | rank/layers | time-units | Difference | of CUs |
| 1 | RI-PMI | 1 | 1 | 1 | 1 |
| 2 | RI-PMI | 1 | 2 | 2 | 1 |
| 3 | RI-PMI | 2 | 3 | 3 | 2 |
| 4 | RI-PMI | 2 | 4 | 4 | 2 |
| 5 | RI-PMI | 3 | 5 | 5 | 3 |
| 6 | RI-PMI | 4 | 6 | 6 | 4 |

Based on the second association rule example in Table 4, when the report quantity is RI, PMI, the allowed rank or the allowed number of layers is 1, the fixed active window duration is 2, the overlapped time-units that causes WTRU computational capability violation is 2, then the additional number of CUs in the active sub-window based on codepoint 2 of Table 4 is 1 CU and the total number of CUs in the active sub-window based on codepoint 2 of Table 4 and codepoint 2 of Table 3 is 1+1=2 CUs. An association rule such as Equation 1 may be used to determine the number of CUs, e.g.,

$${O}_{C U}^{p}$$

based on Ky and Ip, where different values of Kₚ maybe used based on one or more parameters listed in Section 4.2.2, e.g., Kₘ=α*β*u, where

$$\begin{matrix}α = 2 , β = 1 for Type - I codebook and α = 4 , β = 2 for Type - II codebok when {T}_{m} = 1 slot \\ α = 1 , β = 1 for Type - I codebook and α = 2 , β = 2 for Type - II codebok when {T}_{m} = 2 slots \\ u = 1 when report quantity is SINR or RSRP , u = 2 when quantity is RI - PMI - CQI , etc .\end{matrix}$$

Each CSI request may be associated with a respective active window. For example, the active window starts from time-unit X and ends at time-unit Y, including the time-unit X and the time-unit Y. Time-unit X and time-unit Y of an active window for periodic (P), semi-persistent (SP), and/or aperiodic (AP) CSI-RS and the corresponding P, SP, and/or AP CSI reporting is detailed herein. The WTRU may use the selected CUs for determination of the CSI report in the active window. The WTRU may have one or more counters that may keep a count of one or more of the following in an active window,

The WTRU may support a given number of CUs, e.g., N_{CU} CUs. In a given active window, the WTRU may maintain a count of the CUs that are already in use and/or a count of the CUs that are available. The count may enable the WTRU to accept or reject any new CSI request from the gNB within the active window. For example, the WTRU may support N_{CU}=4. The WTRU may receive two or more CSI requests. A first CSI request may be associated with a first active window, e.g., from time-unit 0 to time-unit 3. The first CSI request may require 3 CUs to process the first CSI request in the first active window. A second CSI request may be associated with a second active window, e.g., from time-unit 1 to time-unit 2. The second CSI request may require 2 CUs to process the second CSI request in the second active window. At time-unit 0, 2 CUs may be occupied and 2 CUs may be available. At time-unit 1 and time-unit 2, 4 CUs (e.g., all 4 CUs) may be occupied or busy. At time-unit 3, 2 CUs may be occupied and 2 CUs may be available.

At time-unit 1 or time-unit 2, if the WTRU receives a new CSI request, the WTRU may prioritize the CSI requests based on the priority orders of the CSI request(s). The WTRU may prioritize high priority reports and/or de-prioritize low priority reports (e.g., determine low priority reports at a later time).

The total number of occupied CUs at any given time-unit may not exceed the total number of CUs. For example, when the active windows of the P CSI requests overlap at at-least one time-unit (e.g., symbol), the following must hold,

$${\sum }_{p = 1}^{{P}^{′}} {\sum }_{m = 1}^{M} {\sum }_{n = 1}^{N} {O}_{c u}^{p} ( n , m ) \leq {N}_{C U} \qquad ( 2 )$$

Or, the following must hold,

$${\sum }_{p = 1}^{{P}^{′}} {O}_{c u}^{p} \leq {N}_{C U} \qquad ( 3 )$$

When the gNB configures more CSI requests than the WTRU has the computational power to process, one or more CSI requests may be dropped (e.g., only P′∈{1, . . . , P} number of CSI requests are processed by the WTRU), for example, to satisfy Equation 2 and/or Equation 3.

The WTRU may support or process a given number of CSI-RS resources and/or CSI-RS antenna ports in a given time-units, e.g., in a given slot or in an active window. The WTRU may keep a count of the number of CSI-RS resources and/or CSI-RS antenna ports in an active window or in one or more time-unit, e.g., in a slot.

Outside of the active window, the WTRU may reset the counter. For example, the WTRU may have 4 CUs. The WTRU may receive a CSI request that has an active window and requires 2 CUs. The WTRU may have two counters, one for counting occupied CUs and another for counting un-occupied CUs. During the active window, the occupied CUs may be 2 and the available CUs may be 2. Outside of the CU, assuming there are no other active windows, the number of occupied CUs may be 0 and/or the number of available CUs may be 4.

One or more of the following conditions and/or situations may be termed as WTRU capability violation.

A WTRU capability violation may occur when the number of configured CSI requests requires more CUs than the WTRU supports. For example, three active windows associated with three CSI requests may overlap at at-least one time-unit, e.g., time-unit j. If at time-unit j, the total required number of CUs is more than the WTRU supports, e.g., when Equation 2 and/or Equation 3 is not satisfied at time-unit j, such a condition or CSI request causes WTRU capability violation.

A WTRU capability violation may occur when the number of configured CSI requests has more CSI-RS resources than the WTRU supports in a given time-window, e.g., in a slot or in an active window. For example, three CSI requests may be based on 3 CSI-RS resources in a single slot, whereas the WTRU supports (e.g., only supports) up to 2 CSI-RS resources in a given slot. Such a condition or CSI request causes WTRU capability violation.

A WTRU capability violation may occur when the number of configured CSI requests has more CSI-RS antenna ports than the WTRU supports, in a given time window, e.g., in a slot or in an active window. For example, three CSI requests may be based on 96 CSI-RS antenna ports in a single slot or in an active window, whereas the WTRU supports (e.g., only supports) up to 64 CSI-RS antenna ports in a given slot. Such CSI requests violates WTRU capability.

The gNB may configure more than one CSI requests that may result in a violation of the WTRU capability. For example, the gNB configures 2 CSI requests as illustrated in FIG. 1. The WTRU supports 4 CUs. The 1^{st} CSI request has an associated 1^{st} fixed active window. The 2^{nd} CSI request has an associated 2^{nd} fixed active window. The 1^{st} CSI request requires 3 CUs within the 1^{st} fixed active window for determination of the 1^{st} CSI report. The 2^{nd} CSI request requires 2 CUs within the 2^{nd} fixed active window for determination of the 2^{nd} CSI report. The 2^{nd} CSI request violates the WTRU capability, e.g., during the time duration from the first or last time-unit of 2^{nd} CSI-RS resource(s) to the first or last time-unit of the 1^{st} CSI reporting. The WTRU determines the 1^{st} CSI report and reports it.

Herein, a CSI request that violates the WTRU's capability may be referred to as an invalid CSI request and the CSI request that do not violate a WTRU capability may be referred to as a valid CSI request. The WTRU may do one or more of the following, in response to an invalid CSI request (e.g., the 2^{nd} CSI request in FIG. 1) that violates the WTRU's capability. The WTRU may ignore the invalid request.

The valid CSI request may have an associated priority value, e.g., prio(a). The in-valid CSI request may also have an associated priority value, e.g., prio(b). Based on priorities, e.g., prio(a) and prio(b), the WTRU may prioritize a valid CSI request or an invalid CSI request or it may prioritize an invalid CSI request or a valid CSI request. The priority value to a CSI report may be assigned based on one or more of the following: a CSI-RS resource ID, a CSI-RS resource set ID, or one or more parameters of the CSI request listed in Section 4.2.2.

The CSI requests may have the following exemplary priorities. A valid CSI request may have a higher priority as compared to an invalid CSI request. A first valid CSI request may have a higher priority as compared to a second valid CSI request. A CSI request with a smaller ID (or alternatively a larger ID) may have a higher priority as compared to a CSI request with a higher priority (or alternatively a smaller ID). An invalid CSI request may have a higher priority as compared to a valid CSI request.

The WTRU may prioritize or de-prioritize one CSI request over another CSI request.

The WTRU may determine a CSI based on the invalid CSI request by doing one or more of the following. The WTRU may use more CUs than the CUs that are assigned to the WTRU to process the CSI request, e.g., to process the invalid CSI request. The WTRU may extend the active window, e.g., increase the number of time-units in the active window by extending the last time-unit of the active window and use the assigned number of CUs to determine a CSI or to process the invalid CSI request.

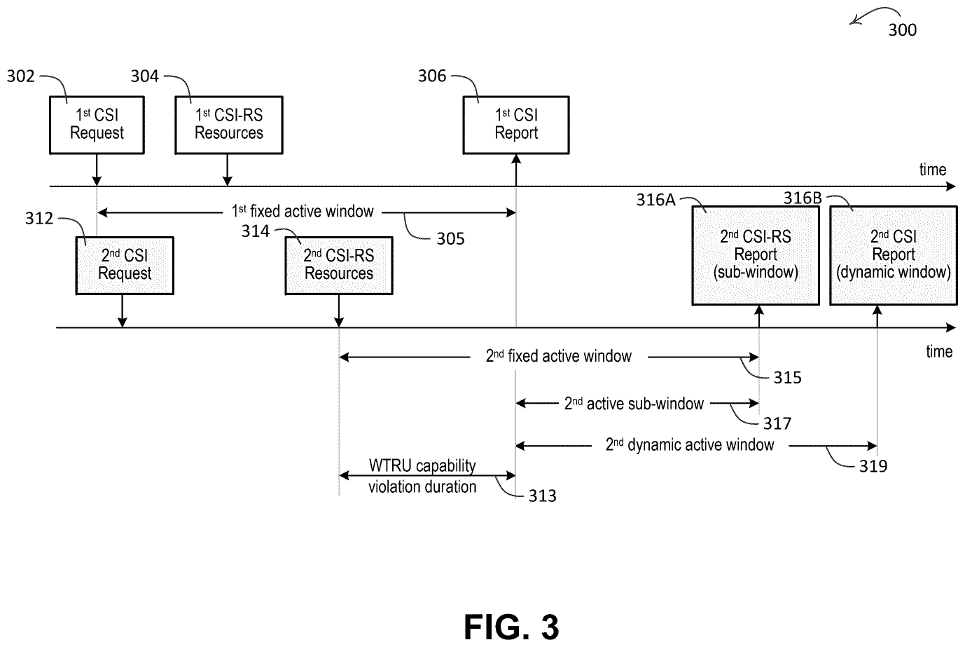

FIG. 3 depicts an example method 300 of CSI determination by a WTRU in a fixed active window, an active sub-window, and a dynamic active window. A WTRU may support a fixed active window. A WTRU may support a variable or dynamic active window. Hereinafter CSI determination in a fixed and dynamic active window are explained.

A WTRU may perform CSI determination in a fixed active window. The WTRU may determine or select a number of CUs based on the configured or fixed association rule for determination of a CSI report. The WTRU may use the determined or selected CUs to determine a CSI in the fixed active window. For example, the WTRU may determine the CSI in the fixed active window based on the determined or selected CUs.

In the event of an invalid CSI request, e.g., as shown in FIG. 3, a second CSI request may violate the WTRU capability. For example, the WTRU may not have sufficient CUs to process the invalid CSI request in the fixed active window of the invalid CSI request. The WTRU may do one or more of the following.

The WTRU may perform CSI determination in a sub-active window. The WTRU may determine, based on the methods and procedures described herein, a number of CUs that are needed to determine a CSI based on the invalid CSI request in the active window of the invalid CSI request. For example, the WTRU may have 4 CUs. A first CSI request 302 (e.g., as shown in FIG. 3) may require 3 CU in a first active window 305. The WTRU may receive one or more first CSI-RS resources 304. The WTRU may send a first CSI report 306, for example, at the end of the first active window 305. A second CSI request 312 may be an invalid CSI request. For example, the WTRU may determine that the second CSI request 312 is an invalid CSI request. The WTRU may determine that it requires 2 CUs to determine a CSI based on the invalid CSI request 312 in a second active window 315, but the WTRU has 1 available CU (e.g., only has 1 available CU), for example, as the remaining 3 CUs are occupied by the first CSI report determination. The WTRU may receive one or more second CSI-RS resources 314. The WTRU may determine an active sub-window 317 associated with the invalid CSI report 312. The active sub-window 317 may be smaller in terms of the number of time-units than the second active window 315 of the invalid CSI request 312. For example, the WTRU may determine the second active sub-window 317 (e.g., as shown in FIG. 3). The last time-unit of the second active window 315 may be the same as the last time unit of the active sub-window 317 may be the same. Alternatively, the first time-unit of the active sub-window 317 may be different than the first time-unit of the active window 315, e.g., the first time-unit of the active sub-window 317 may come after the first time-unit of the active window 315. The WTRU may send a second CSI report 316A at the end of the second active sub-window 317 and/or the end of the second active window 315.

The WTRU may use a higher number of CUs during the active sub-window 317 of the invalid CSI request 312 to determine a CSI based on the invalid CSI request 312. For example, as shown in FIG. 3, after reporting of the first CSI report 304, 4 CUs (e.g., all 4 CUs) of the WTRU may be available for the WTRU. The WTRU may use the 4 CUs (e.g., all the 4 CUs) or 3 CUs to determine a CSI.

Supporting CSI determination in a sub-active window may be a WTRU capability. The WTRU may report its capability to the gNB that it supports CSI determination based on an active sub-window.

The WTRU may process (e.g., only process) an invalid CSI request 312 or determine a CSI based on an invalid CSI request 312 in an active sub-window 317 such that it may not jeopardize a valid CSI request (e.g., such as the first CSI request 302). For example, the WTRU may receive two CSI requests-a valid CSI request 302 and an invalid CSI request 312. The WTRU may have sufficient computational resources to determine one (e.g., only one) out of the two CSI requests. The WTRU may prioritize determination of the valid CSI request 302. In examples, the additional CUs needed to process the second CSI request 312 in an active sub-window 317 may be determined using a second association rule. The second association rule may include one or more parameters of the first association rule and the number of overlapped time-units in the active windows 305, 315 of the CSI requests 302, 312, that are taking CUs for processing other CSI requests, thus violating the WTRU's computational capability in the active window 315 of the invalid CSI request 312.

For example, the WTRU may have 4 CUs. The WTRU receives two or more CSI requests (e.g., such as the CSI requests 302, 312). The first CSI request 302 has an active window 305 that starts from time-unit 1 and ends and time-unit 10. The second CSI request 312 has an active window 315 that starts from time-unit 6 and ends and time-unit 15. The first CSI request 302 using a first association rule needs 3 CUs to process the request. The second CSI request 312 using the first association rule needs 2 CUs to process the request. A second association rule may implicitly or explicitly indicate that one additional CU is needed if the number of overlapped time-units are 1, 2, and/or 3 and two additional CUs are needed if the number of overlapped time-units are 4 and/or 5. In the considered example, the number of overlapped time-units may be 5. Therefore, based on the second association rule, two additional CUs may be needed to process the second CSI request 312 in the active sub-window 317 of the second CSI request 312. An example of the second association rule is as illustrated in Table 4.

A WTRU may perform CSI determination in a dynamic active window. The WTRU may support shrinking (e.g., reducing the number of time-units in the active window or reducing the length of the active window) or extending (e.g., increasing the number of time-units in the active window) the active window associated with a CSI request. For example, the WTRU supports shrinking the active window. The WTRU may support 4 CUs. A CSI request 312 may have an associated active window 315 that has 10 time-units, e.g., starting from the sixth time-unit to the fifteenth time-unit. Time-unit from the sixth time-unit to the tenth time-unit may be considered a WTRU capability violation duration 313. The WTRU may need 3 CUs to determine a CSI in the associated active window 315 (e.g., sixth to fifteenth time-unit) of the invalid CSI request 312. The WTRU may change the active window 315, e.g., to a dynamic active window 319 to determine a CSI report 316B, e.g., the active window 315 from the sixth time-unit to fifteenth time-unit is being changed by the WTRU to a dynamic active window 319, where the dynamic active window 319 starts from the eleventh time-unit and ends at the twentieth time-unit. The WTRU may use 3 CUs in the dynamic active window 319 to determine a CSI based on the in-valid CSI request 312.

The WTRU may support extending the starting time-unit of the active window by a number of time-units. The number of time-units, that the WTRU may be able to extend the starting time-unit of the active window may be reported by the WTRU to the gNB. For example, the WTRU may report that it supports extending the starting time-unit of the active window by 4 time-units. In the example considered above, the WTRU may be able to shift the active window that starts from the sixth time-unit and ends at the fifteenth time unit to a dynamic active window that starts at the tenth time-unit and ends at the nineteenth time-unit.

The WTRU may support extending the number of time-units of an active window by a number of time-units. The number of time-units, that the WTRU may be able to extend may be reported by the WTRU to the gNB. For example, the WTRU may report that it supports extending the active window by 4 time-units. In the example considered above, the WTRU may be able to extend the number of time-units in the active window from ten time-units to twelve time-units. For example, the dynamic active window may start from the sixth time-unit and end at the seventeenth time-unit. In another example, the dynamic active window may start at the eleventh time-unit and end at the twenty-second time-unit.

The WTRU behavior of CSI reporting may depend on the active window used for determination of the CSI report.

When the CSI is determined in a fixed active window, the WTRU may report the CSI determined in the fixed active window associated with the CSI request and send the determined CSI report to the gNB in the CSI reporting resources assigned to the WTRU by the gNB.

When the CSI is determined in a sub-active and dynamic active window, one or more invalid CSI requests may violate the WTRU capability. The WTRU may process one or more invalid CSI requests or determine a CSI based on one or more CSI requests during their corresponding sub-windows, or dynamic active window. Sub-windows or dynamic windows of two or more invalid CSI requests may overlap in at-least one time-unit. The WTRU may select or prioritize one CSI request over another CSI request. In such a case, the WTRU may send the CSI request ID in the CSI report to indicate to the gNB the CSI report index that the WTRU determined and reported.

When the CSI is determined in a dynamic active window, the WTRU may send an indicator to the gNB that indicates the index of a CSI request and that indicates a CSI for the reported index was determined by the WTRU and ready for reporting to the gNB. The gNB may assign resources, e.g., PUCCH resources to the WTRU for reporting of the determined CSI or the CSI buffered by the WTRU.

The CSI reports may be reported at different priorities. The WTRU may use the priorities as defined herein.

The WTRU capabilities that are discussed, proposed, or highlighted herein except the legacy capabilities(s) may be referred to as new capabilities or advanced capabilities.

In examples, a WTRU may indicate its CSI processing capability based on one or more dimensions. A WTRU may reshape its processing capability dynamically according to the requested/triggered/configured CSI report. A WTRU may report its CSI processing capability based on one or more of the following dimensions: a number of the parallel processing, a number of CUs per thread or sub-CUs, a processing rate, and/or a unit processing time per CU in thread. A WTRU may rearrange its processing capability to support B parallel processing branch, or threads, where each thread may be characterized by a different processing capability. A WTRU may report its CSI processing capability per thread by reporting an associated N_{CU} (b), where b=1, . . . , B, where N_{CU} (b) represent the number of supported simultaneous CSI calculations per thread. A WTRU may indicate its fastest possible unit CSI processing capability, represented by the processing time TO, where TO represents the shortest possible processing time required for a CSI processing corresponding to 1° C. PU, supported in at least one branch. A WTRU may further report its CSI processing capability per CU per thread by T_{CU}(b)=k (b). T0, where k(b)≥1 is a scaling factor.

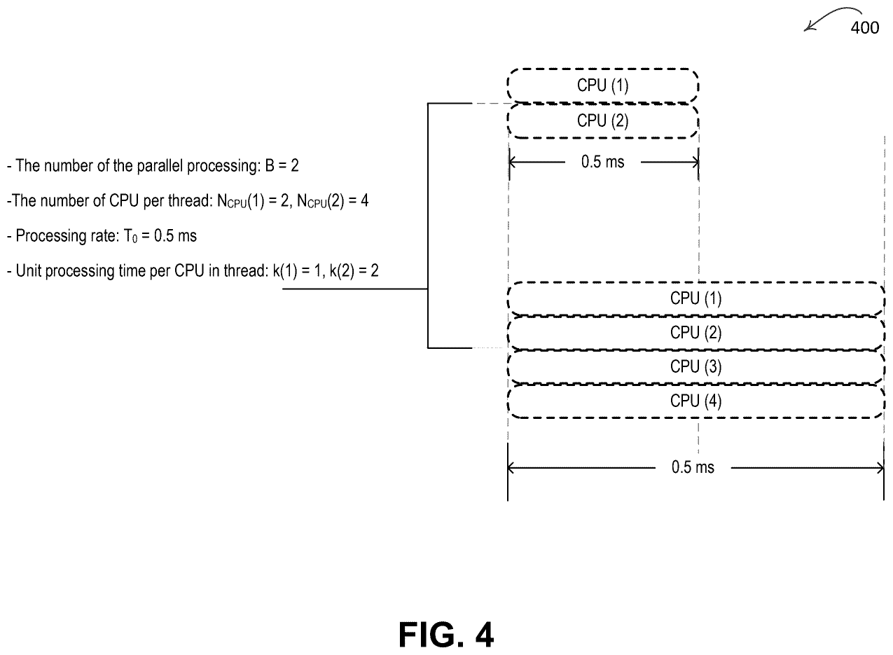

FIG. 4 depicts an example declaration 400 of reported capability. In examples, a WTRU may indicate the followings set of parameters: the number of the parallel processing: B=2, the number of CPU per thread: N_{CU} (1)=2, N_{CU} (2)=4, processing rate: T0=0.5 ms, unit processing time per CU in thread: k(1)=1, k(2)=2.

As demonstrated in FIG. 4, the WTRU may declare a processing capability of support of 2 parallel processing branches, where the first branch is capable of supporting 2 simultaneous CSI calculations in 0.5 ms and the second branch is capable of support of 4 simultaneous CSI calculations in 1 ms.

In examples, a WTRU may indicate more than one combination of the above capability parameters, from which one set may be employed for the CSI computations.

A WTRU may receive a dynamic, e.g., a DCI or MAC-CE, or a semi-static indication to use a specific set of parameter combination for CSI processing.

In examples, a WTRU may receive an indication from gNB to use a specific set of parameter configuration. For example, the gNB may require the WTRU to use a setting that is the most beneficial for a highly loaded network or a highly mobile WTRU.

Additionally or alternatively, when a WTRU enters a specific mode of operation, e.g., power saving, the WTRU may request a preferred set of parameter combinations for CSI processing. The WTRU may switch from one set of parameters to another, for example, based on an indication to confirm the WTRU's request.

In examples, a WTRU may indicate and proceed with use of a specific parameter setting without gNB confirmation.

In examples, a CSI trigger may also indicate a specific set of parameter combinations for the triggered CSI report. For example, gNB may request a first configuration corresponding to faster processing for some CSI report (e.g., only for some CSI report), e.g., time critical, while requesting a second configuration for other types of CSI. In examples, if a CSI trigger does not include any indication for parameter combination, a default set of parameter combinations may be used.

As used herein, an active window may refer to a time window or the time window in which one (or more) CSI-RS resource(s) is (are) counted as active and/or a time window or the time window in which one or more CSI-RS antenna port(s) that is (are) mapped to an active CSI-RS resource is counted as an active antenna port(s).

The length and position of active window, active sub-window, and dynamic window may be different for different CSI requests, e.g., for P, SP, or AP CSI-RS and/or P, SP, and/or AP CSI reporting. Hereinafter, different active windows are discussed and/or presented. One or more of the following presented active windows may be a WTRU capability. The WTRU may report one or more of the active windows it supports. For example, the WTRU may report that for aperiodic CSI-RS and aperiodic CSI reporting, the WTRU supports a first active window.

The last time-unit index of an active window may depend on one or more of the following, the subcarrier spacing of the DL transmission (e.g., the subcarrier spacing of PDSCH), the subcarrier spacing of the UL transmission (e.g., the subcarrier spacing of the UL channel used for reporting the CSI), the subcarrier spacing of the CSI-RS, or the maximum, average or minimum subcarrier spacing among the subcarrier spacings of PDSCH, UL channel used for the CSI reporting and the CSI-RS.

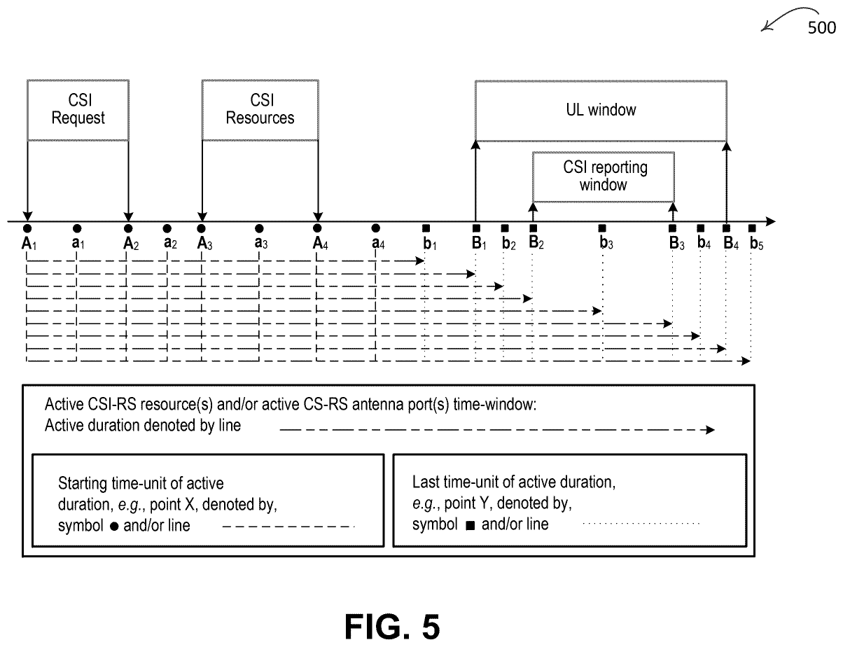

FIG. 5 depicts example candidate time-units 500 starting time-unit and ending time unit of an active window when the CSI reference signal (CSI-RS) resources are aperiodic. A WTRU may send its capability that it supports active window that starts at point-X in time and ends at point-Y in time. For example, Point-X in time or the candidate time-units for the first time-unit of the active window may be one or more of the following. The first (e.g., A₁) or the last (e.g., A₂) time-unit of the trigger that requests the CSI report, or any time-unit (e.g., a₁) between the first (e.g., A₁) and the last (e.g., A₂) time-unit of the trigger that requests the CSI report, or any time-unit (e.g., a₂) between the last (e.g., A₂) time-unit of the CSI request and the first (e.g., A₃) time-unit of the CSI-RS resource. The first (e.g., A₃) or the last time-unit (e.g., A₄) of the CSI-RS resource used by the WTRU for determination of the CSI report, or any time-unit (e.g., a₃) between the first (e.g., A₃) and the last time-unit (e.g., A₄) of the CSI-RS resource used for determination of the CSI report, or any time-unit (e.g., a₄) between the last time-unit (e.g., A₄) of the CSI-RS resource used for determination of the CSI report and the first time-unit (e.g., B₁) of the UL window, or the first time-unit (e.g., B₁) of the UL window, the first (e.g., B₂) time-unit of the CSI reporting window, the last time-unit (e.g., B₃) of the CSI-RS reporting window, the last time-unit (e.g., B₄) of the UL window, any time-unit (e.g., b₁) before the first (B₁) of the UL window, any time-unit (e.g., b₂, b₃, b₄) between the first (e.g., B₁) time-unit of the UL window and the last (e.g., B₄) time-unit of the UL window. Any (e.g., b₅) time-unit after the last (e.g., B₄) time-unit of the UL window.

Point-Y in time or the candidate time-units for the last time-unit of the active window may be one or more of the following, any time-unit starting from the first (e.g., A₁) time-unit of the CSI request to one or more time-units after reporting of the CSI or after the UL window. An example of point X and point Y are denoted in FIG. 5.

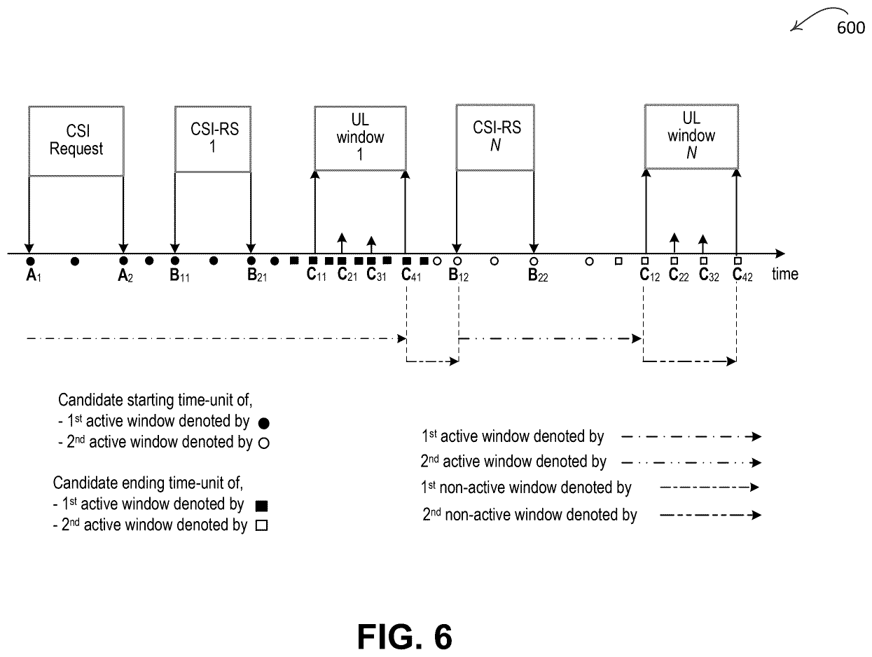

FIG. 6 is a diagram illustrating active windows 600 in periodic and semi-persistent CSI-RS, including candidate time-units of the first and last time-unit of each active window. Multiple active windows, active sub-windows, or dynamic windows as shown in FIG. 6 may be defined when the CSI-RS resources are periodic, and the CSI reporting is also periodic. The durations of such multiple windows may be the same or different. For example, two types of active windows may be specified, e.g., a longer active window and a shorter active window and the position of the active windows may be as follows. A longer active window followed by a shorter active window. The shorter active window may then be followed by a longer active window and so on. A shorter active window followed by a longer active window. The longer active window is then followed by a shorter active window and so on.

A starting time-unit of each active window may be any time-unit between the first time-unit of the CSI request and the last time-unit of the UL window of the corresponding report. The time-units or the window between the last time-unit of a first active window and the first time-unit of the second active window may be specified or treated by the WTRU and the gNB as a non-active sub-window.

One or more active windows may be defined when the CSI-RS resources are periodic, and CSI reporting is semi-persistent. The first active window may start between any time unit before the latest CSI-RS resource that is before the first CSI reporting instance and any time unit that is after the first CSI reporting instance. The second active window may start between any time unit before the latest CSI-RS resource that is before the second CSI reporting instance and any time unit that is after the second CSI reporting instance.

For example, the first CSI report may be determined based on the fifth CSI-RS resource occasion of the semi-persistent CSI-RS occasions. The first time-unit of the fifth CSI-RS resource is 15. The last time unit of the first CSI reporting instance is 20. The first active window may start at time-unit 15 and the last time unit of the first active window may be time-unit 20.

For example, the first CSI report may be determined based on the fifth CSI-RS resource occasion of the semi-persistent CSI-RS occasions. The first time-unit of the fifth CSI-RS resource is 15. The last time unit of the first CSI reporting instance is 20. The first active window may start at time-unit 16 and the last time unit of the first active window may be time-unit 19.

One or more active windows may be defined when the CSI-RS resources are periodic, and CSI reporting is aperiodic. The number of active windows may depend on the number of aperiodic CSI reporting instances. The first active window may start between any time unit before the latest CSI-RS resource that is before the first aperiodic CSI reporting instance and any time unit that is after the first aperiodic CSI reporting instance.

For example, the aperiodic CSI report may be determined based on the fifth CSI-RS resource occasion of the periodic CSI-RS occasions. The first time-unit of the fifth CSI-RS resource occasion is 15. The last time unit of the first CSI reporting instance is 20. The first active window may start at time-unit 15 and the last time unit of the first active window may be time-unit 20.

One or more active windows may be defined when the CSI-RS resources are semi-persistent, and CSI reporting is also semi-persistent. The number of active windows may be equal to one or equal to the number of semi-persistent CSI reporting occasions. The active window may start at the trigger triggering the semi-persistent CSI-RS resources and the last time unit where the CSI-RS resources are released.

For example, the semi-persistent CSI-RS resources are triggered at time unit 0 and released at time unit 30. The active window starts from time-unit 0 and ends at time unit 30.

The active windows may be the same as the active windows for periodic CSI-RS and aperiodic CSI reporting.

A WTRU may support a fixed active window where point X and point Y of the fixed active window for a CSI-RS type and the type of CSI reporting may be based on the above-mentioned time-units.

The WTRU behavior in a fixed active window may be as described herein.

An active sub-window may be an active window that has a smaller duration as compared to the active window and the first time-unit of the active sub-window is the time-unit within the active window when at-least one new CU becomes available, and the last time-unit of the active sub-window is the same as the last time-unit of the active window.

WTRU behavior in an active sub-window may be as described herein.

A dynamic or a variable active window may refer to an active window whose starting time-unit, e.g., time-unit X, ending time-unit, e.g., time-unit Y, and/or the number of time-units between the time-unit X and the time-unit Y may change or may be changed by the WTRU.

The WTRU may report its capability of supporting dynamic or variable active window.

For example, the active window may begin at time-unit 10 and end at time-unit 15. The WTRU may extend the active window to time-unit 20. The dynamic active window may start from time-unit 10 and end at time-unit 20. The window is extended by U=5 time-units. The value of U may be a WTRU capability.

One or more association rule(s) or table(s) may be defined or specified so that the gNB may use it to configure CSI requests such that the WTRU capability is not violated while the WTRU may use such an association rule to determine or select a number of CUs, or sub-CUs for processing a CSI request or for determining a CSI in an active window.

The association rule may be defined using a mathematical equation (e.g., such as Equation 1) and using one or more Tables (e.g., such as Table 1, Table 2, and/or Table 3). Selecting or determining CUs or sub-CUs based on an association rule is described herein. One or more guidelines and/or CSI related parameters may be used to design an association rule.

The association rule may be based on one or more of the following parameters: a number of bandwidth parts (BWPs), a number of active BWPs, a number of component carriers (CCs), or one or more timing related parameters, (e.g., such as a number of time-units in an active window or duration of an active window, a number of time-units in an active sub-window or duration of an active sub-window, a number of time-units in a dynamic active window or duration of a dynamic active window, a parameter value that may denote a time duration, e.g., parameter Z and Z′ and parameter T_{proc} and T_{proc}′, a subcarrier spacing of downlink data transmission, downlink CSI-RS transmission, UL transmission, a maximum subcarrier spacing among the subcarrier spacings of downlink data transmission, downlink CSI-RS transmission, UL transmission, a minimum subcarrier spacing among the subcarrier spacings of downlink data transmission, downlink CSI-RS transmission, UL transmission or one or more time-unit indexes between the first time-unit of the CSI request and the last time-unit of the UL window where the CSI is reported or one or more time-units after the last time-unit of the UL window.

The association rule may be based on one or more codebook related parameters such as one or more of the following. The one or more codebook related parameters may include a first Type of a single panel codebook or a first Type of a multi-panel panel codebook. The one or more codebook related parameters may include a second Type of a single panel codebook or a second Type of a multi-panel codebook. The one or more codebook related parameters may include an integer value of discrete Fourier transform (DFT) oversampling. The one or more codebook related parameters may include a number of CSI-RS antenna ports (e.g., a number of ports when Rel-19 Type-I Scheme-A codebook is configured and/or a number of ports when Rel-19 Type-I Scheme-B codebook is configured). The one or more codebook related parameters may include a number of spatial domain basis, time domain basis, and/or Doppler domain basis. The one or more codebook related parameters may include a frequency domain, time domain, spatial domain compression parameters, e.g., a number of non-zero coefficients in a Type-II CSI report and/or a number of precoders per sub-bands. The one or more codebook related parameters may include a codebook type, e.g., Rel-19 Type-I codebook scheme-A and/or Type-I codebook scheme-B). The one or more codebook related parameters may include a number of sub-bands. The one or more codebook related parameters may include a number of active BWPs. The one or more codebook related parameters may include a number of CSI sub-configurations. The one or more codebook related parameters may include a number of CSI-RS antenna ports in a CSI sub-configuration

The association rule may be based on a report quantity (e.g., such as a wideband precoding matrix index, a sub-band precoding matrix index, a wideband channel quality indicator, and/or a sub-band channel quality indicator.

The association rule may be based on a rank value (e.g., such as an allowed rank value, an allowed number of layers, one or more allowed layer indexes, a maximum global rank value, and/or a number of layers transmitted using a spatial beam, e.g., number of layers in a group of layers, where the group of layers are transmitted using a single beam).

The association rule may be based on a number of beams to be reported by the WTRU.

An example of the association rule based on a few of the above-mentioned parameters is listed in Table 5. Table 5 depicts an example association rule involving different configuration parameters, duration of the active window for CUs determination.

TABLE 5

| | Parameters of the | Required CUs | | |
|---|---|---|---|---|
| Codepoint | association rule | 5 | 8 | 12 |
| 1 | Report quantity | RI-PMI | RI, PMI, SCQI | RI, i1, W-CQI |
| 2 | Allowed rank | 1 | 2 | 3 |
| 3 | Duration of active window | 5 | 10 | 15 |
| 4 | Number of sub-bands | 10 | 15 | 20 |
| 5 | Codebook Type | Type-I SP | Type-II | Type-II |
| | | | | port-selection |
| 6 | Subcarrier spacing of | 15 KHz | 30 KHz | 15 KHz |
| | PUCCH | | | |
| 7 | Number of CSI-RS | 12 | 24 | 64 |
| | antenna ports | | | |

More than one association rule may be defined, configured, or indicated. The WTRU may use an association rule to select a number of CUs for determination of a CSI report that maps to the WTRU capability.

For example, two association rules may be defined. The WTRU may indicate that it supports a first association rule. The WTRU may assume that it should use the first association rule for selection of a number of CUs for determination of a CSI report.

A WTRU may support one or more rules or codepoints of an association rule. For example, a WTRU may report that it supports CUs determination based on codepoints 1, 3, 4, and 5 of Table 4.

The WTRU may not expect to be configured with an invalid CSI request that may violate the capability of the WTRU, e.g., the computational capability of the WTRU. However, the WTRU may request one or more invalid CSI request that violates WTRU capability. In a such a situation, the WTRU may prioritize processing a valid CSI request over an invalid CSI request, the WTRU may prioritize processing an invalid CSI request over a valid CSI request, and/or the WTRU may prioritize processing a first invalid CSI request over a second invalid CSI request.

Therefore, priority rules are needed so that the gNB and the WTRU knows or have a common understanding of what CSI requests the WTRU may prioritize or de-prioritize in the event of WTRU's computational capability violation.

In examples, a CSI report associated with a valid CSI request may have a higher priority as compared to a CSI report associated with an invalid CSI request.

In examples, the WTRU may prioritize a maximum number of CSI requests that do not violate the capability of WTRU so that the WTRU may estimate or sound one or more BWPs or CCs (e.g., all BWPs or CCs).

In examples, the WTRU may prioritize the minimum number of CSI requests that do not violate the computational capability of the WTRU. Such reports may be time-critical to the gNB.

In examples, the WTRU may prioritize a valid or invalid CSI request over a valid CSI request.

For a CSI request, e.g., a valid CSI request or an invalid CSI request may have an associated fixed or indicated (e.g., semi-statically and/or dynamically indicated) priority indication.

For example, the WTRU may receive 2 CSI requests, e.g., a valid CSI request and an invalid CSI request. The invalid CSI request may have a higher priority as compared to a valid CSI request. The WTRU may process both the valid CSI request and the invalid CSI request, for example, if the WTRU has sufficient computational resources to determine both CSIs in their corresponding fixed active window and the active sub-window. If the WTRU does not have sufficient computational resources, the WTRU may prioritize processing the invalid CSI request over the valid CSI request.

In examples, the WTRU may prioritize a lower priority CSI request over a higher priority CSI request based on the available computational resources at the WTRU.

For example, the WTRU may have 4 CUs. The WTRU may receive 2 CSI requests, e.g., a first CSI request and a second CSI request. The first CSI request may require 3 CUs, and the second CSI request may require 1 CU. The first CSI request may have a higher priority as compared to the second CSI request. The WTRU may have 2 unoccupied CUs and 2 occupied CUs in the active window of the first CSI request and the active window of the second CSI request. Based on the priority rules, the WTRU may prioritize the first CSI request. However, the WTRU may prioritize the second CSI request over the first CSI request. The gNB may expect the WTRU to send the second CSI report as it knows that the WTRU will prioritize a low priority report in such a scenario.

The iₜₕ CSI report may have an associated priority value that is assigned to the report using the following function:

$$P r {i}_{iCSI} ( y , k , c , s ) = 2 \cdot {N}_{c e l l s} \cdot {M}_{s} \cdot y + {N}_{c e l l s} \cdot {M}_{s} \cdot k + {M}_{s} \cdot c + s$$

### Where:

y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH;
k=0 for CSI reports carrying L1-RSRP or L1-SINR and k=1 for CSI reports not carrying L1-RSRP or L1-SINR;
c is the serving cell index and N_{cells} is the value of the higher layer parameter maxNrofServingCells; for a CSI report configured with LTM-CSI-ReportConfig, c is the serving cell index value where the report configuration is configured.
s is the reportConfigID and Mₛ is the value of the higher layer parameter maxNrofCSI-ReportConfigurations. For a CSI report configured with LTM-CSI-ReportConfig, s is the LTM-CSI-ReportConfigID and Ms is the value of the higher layer parameter maxNrofLTM-CSI-ReportConfigurations

An iₜₕ CSI report is said to have priority over a i′ CSI report if the associated Pri_{iCSI} (y, k, c, s) value is lower for the iₜₕ report than Pri_{i′CSI} (y, k, c, s) value of the iₜₕ′ report.

In examples, a parameter may be added into the existing priority equation that would account for the proposed priority rules. For example, one may add a variable “t” such as:

$$P r {i}_{iCSI} ( y , k , c , s , t ) = 2 \cdot {N}_{c e l l s} \cdot {M}_{s} \cdot y + {N}_{c e l l s} \cdot {M}_{s} \cdot k + {M}_{s} \cdot c + s + t$$

Where t has a smaller value for a higher priority CSI request and has larger value for a smaller priority CSI request, e.g., t make take value between −5 and 5 based on the priority of the CSI request.

Additionally or alternatively, new values may be assigned to the existing parameters of the existing equation. For example, new values of y may be added to the equation as, y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH, y=4 for aperiodic CSI reports based on invalid CSI request and to be carried on PUSCH y=5 for semi-persistent CSI reports based on invalid CSI request and to be carried on PUSCH, y=6 for semi-persistent CSI reports based on invalid CSI request and to be carried on PUCCH and y=7 for periodic CSI reports based on invalid CSI request and to be carried on PUCCH;

A WTRU may support both methods for CU counting: the legacy method based on the fixed counting of CUs associated to each CSI report, and the enhanced method described herein with flexible CU counting.

Based on the WTRU's reported capability, the WTRU may be configured to perform one of the methods. The WTRU may receive a configuration to indicate which method applies, and the WTRU may start counting the CUS according to the configured method after a time delay from the time the WTRU received the configuration. If the WTRU is currently in the process of counting CUs according to one method, and receives the indication to switch methods, the WTRU may continue using the same method until the WTRU finished transmitting one or more active CSI reports (e.g., all active CSI reports), and may start using the new rule after that. Additionally or alternatively, the WTRU may stop procedures related to all active CSI reports (e.g., calculating CSI contents), and the WTRU may drop the CSI reports. The WTRU may restart the procedures related to one or more CSI reports (e.g., all CSI reports) after a time delay from the time the WTRU received the indication to switch CU methods.

Additionally or alternatively, if the WTRU supports both methods, the WTRU may initiate a fallback procedure to determine which method to use. The WTRU may also support multiple versions of the flexible CU counting method where each version is associated to one set of parameters to determine the CU counting rule (e.g., beta, K and T values). The WTRU may consider one or more of the following conditions to determine which CU counting method to follow.

Each CU counting method may be associated to the WTRU's RRC state (e.g., IDLE, INACTIVE, CONNECTED), and the WTRU may determine which method to use as a function of the change in the WTRU's RRC state

If the WTRU detects beam failure according to 3GPP beam failure detection methods, the WTRU may fall back to a default CU counting method during the period where the WTRU searches for a new beam to re-establish connection

If the WTRU determines and signals to the network that it enters in a power saving mode where its monitoring capabilities may be reduced, the WTRU may determine to switch from one CU counting method to another one.

Different CU counting methods/parameters may be associated to different TRPs (e.g., coresetPoolIndex), and the WTRU may apply the different rules as a function of the TRP associated to the CSI reporting resource.

If the WTRU is reporting CSIs towards different TRPs where each TRP is configured with a different rule, and the timelines between the different CSI reports overlap, the WTRU may fall back to a default counting rule which may be based on a priority index between the TRPs (e.g., the WTRU reports the CSI using the rule of the prioritized TRP, and drops the CSI for the other TRP), or based on a prioritized counting rule (e.g., the WTRU reports the CSI using the legacy method only and drops reports using the flexible method, or vice-versa)

Additionally or alternatively, the WTRU may determine which rule to prioritize (e.g., which CSI report to transmit and which one to drop), and the CSI report may include a field so that the WTRU may indicate that the associated CSI report is prioritized. If the WTRU is configured with multiple flexible CU counting methods with different beta, K and T values, the WTRU may indicate which set of beta, K and T values are preferred in a CSI report. The WTRU may determine the values based on the WTRU's measurement of channel quality (e.g., RSRP, SINR, SNR), the WTRU's battery level, the number of CSI reports configured/monitored.

1. A wireless transmit/receive unit (WTRU) comprising:
a memory and a processor, wherein the processor is configured to:
receive a first channel state information (CSI) request and a second CSI request;
determine a first active window for the first CSI request and a second active window for the second CSI request;
determine, based on a first association rule, a first number of computational units (CUs) needed to process the first CSI request in the first active window and a second number of CUs needed to process the second CSI request in the second active window;
determine that the second CSI request is an invalid CSI request based on the first number of CUs and the second number of CUs and a number of CUs available to the WTRU;
determine an active sub-window for the second CSI request;
determine, based on a second association rule, a number of additional CUs needed to process the second CSI request in the active sub-window; and
on a condition that the determined number of additional CUs are available, process the second CSI request;
on a condition that the determined number of additional CUs are not available, shift the second active window in time to determine a dynamic active window to process the second CSI request; and
send a CSI report associated with the second CSI request.

2. The WTRU of claim 1, wherein the processor is further configured to send a capability report that indicates one or more of the number of CUs available to the WTRU, a number of sub-CUs in one or more of the CUs, a time duration of each CU and each sub-CU, an active window, an active sub-window, or the dynamic active window.

3. The WTRU of claim 1, wherein the processor is further configured to receive one or more first CSI-RS resources associated with the first CSI request and one or more second CSI-RS resources associated with the second CSI request.

4. The WTRU of claim 1, wherein the first association rule comprises one or more time-related and codebook related parameters associated with the one or more of the first CSI request or the second CSI request, and wherein the second association rule is associated with a number of overlapped time-units in the second active window of the second CSI request.

5. The WTRU of claim 1, wherein the processor is further configured to determine a CSI in the dynamic active window when the number of additional CUs are available, and wherein the number of additional CUs are determined based on the first association rule.

6. The WTRU of claim 1, wherein the second CSI request is determined to be an invalid request based on the second number of CUs needed to process the second CSI request in the second active window being greater than the number of available CUs.

7. The WTRU of claim 1, wherein the processor is further configured to:
send a CSI request ID and an indication that the CSI associated with the CSI request ID is being determined and ready for reporting; and
receive uplink resources to be used for sending the CSI report.

8. The WTRU of claim 1, wherein the active sub-window for the second CSI request comprises a subset of the second active window.

9. The WTRU of claim 1, wherein the first active window starts at a first time-unit and ends at a second time-unit, and wherein the second active window starts at a third time-unit and ends at a fourth time-unit.

10. The WTRU of claim 1, wherein the first number of CUs needed to process the first CSI request in the first active window are determined based on a first duration of the first active window, and wherein the second number of CUs needed to process the second CSI request in the second active window are determined based on a second duration of the second active window.

11. A method performed by a wireless transmit/receive unit (WTRU), the method comprising:
receiving a first channel state information (CSI) request and a second CSI request;
determining a first active window for the first CSI request and a second active window for the second CSI request;
determining, based on a first association rule, a first number of computational units (CUs) needed to process the first CSI request in the first active window and a second number of CUs needed to process the second CSI request in the second active window;
determining that the second CSI request is an invalid CSI request based on the first number of CUs and the second number of CUs and a total number of CUs available to the WTRU;
determining an active sub-window for the second CSI request;
determining, based on a second association rule, a number of additional CUs needed to process the second CSI request in the active sub-window; and
on a condition that the determined number of additional CUs are available, processing the second CSI request;
on a condition that the determined number of additional CUs are not available, shifting the second active window in time to determine a dynamic active window to process the second CSI request; and
sending a CSI report associated with the second CSI request.

12. The method of claim 11, further comprising sending a capability report that indicates one or more of the total number of CUs available to the WTRU, a number of sub-CUs in one or more of the CUs, a time duration of each CU and each sub-CU, an active window, an active sub-window, or the dynamic active window.

13. The method of claim 11, further comprising receiving one or more first CSI-RS resources associated with the first CSI request and one or more second CSI-RS resources associated with the second CSI request.

14. The method of claim 11, wherein the first association rule comprises one or more time-related and codebook related parameters associated with the one or more of the first CSI request or the second CSI request, and wherein the second association rule is associated with a number of overlapped time-units in the second active window of the second CSI request.

15. The method of claim 11, further comprising determining a CSI in the dynamic active window when the number of additional CUs are available, and wherein the number of additional CUs are determined based on the first association rule.

16. The method of claim 11, wherein the second CSI request is determined to be an invalid request based on the second number of CUs needed to process the second CSI request in the second active window being greater than the number of available CUs.

17. The method of claim 11, further comprising:
sending a CSI request ID and an indication that the CSI associated with the CSI request ID is being determined and ready for reporting; and
receiving uplink resources to be used for sending the CSI report.

18. The method of claim 11, wherein the active sub-window for the second CSI request comprises a subset of the second active window.

19. The method of claim 11, wherein the first active window starts at a first time-unit and ends at a second time-unit, and wherein the second active window starts at a third time-unit and ends at a fourth time-unit.

20. The method of claim 11, wherein the first number of CUs needed to process the first CSI request in the first active window are determined based on a first duration of the first active window, and wherein the second number of CUs needed to process the second CSI request in the second active window are determined based on a second duration of the second active window.
